(19) United States
(12) Patent Application Publication
(10) Pub. No.: US 2016/0019601 A1
(43) Pub. Date: Jan. 21, 2016

(54) SYSTEM AND METHOD FOR MODERATING, EVALUATING, AND ESCALATING MULTIMEDIA FILES

(71) Applicant: Lee Zinser, Brooklyn, NY (US)

(72) Inventor: Lee Zinser, Brooklyn, NY (US)

(21) Appl. No.: 14/332,453

(22) Filed: Jul. 16, 2014

(51) Int. Cl. G06Q 30/02; G06F 17/30

(52) U.S. Cl. CPC G06Q 30/0277; G06F 17/30058

(57) ABSTRACT

The present invention generally relates to interactive advertisements. Specifically, the present invention relates to a system and method for providing professional moderation, weighted evaluation, and an escalation of multimedia files ranking. Multimedia files subjected to this process have the result of enhanced user enjoyment and escalating remuneration for multimedia submitters.

### FIELD OF THE INVENTION

The present invention generally relates to interactive advertisements. Specifically, the present invention relates to a system and method for providing professional moderation, weighted evaluation, and an escalation of multimedia files ranking. Multimedia files subjected to this process have the result of enhanced user enjoyment and escalating remuneration for multimedia submitters.

### BACKGROUND

There are number of multimedia, uploading, voting, tagging, and evaluating systems. The result is: an unorganized collection and mislabeled collection of files, out of balance, haphazard (hence the term viral) and backward weighted evaluation and elevation of multimedia files, and a unfair, disproportionate, and disconnected process of remuneration based on real and perceived talent. The systems and methods described herein solves all these problems.

### BRIEF DESCRIPTION OF THE DRAWINGS

FIG. 1 illustrates a schematic overview of a computing device, in accordance with an embodiment of the present invention; and

FIG. 2 illustrates a network schematic of a system, in accordance with an embodiment of the present invention.

### DETAILED SPECIFICATION

The present invention generally relates to interactive advertisements. Specifically, the present invention relates to a system and method for providing professional moderation, weighted evaluation, and an escalation of multimedia files ranking. Multimedia files subjected to this process have the result of enhanced user enjoyment and escalating remuneration for multimedia submitters.

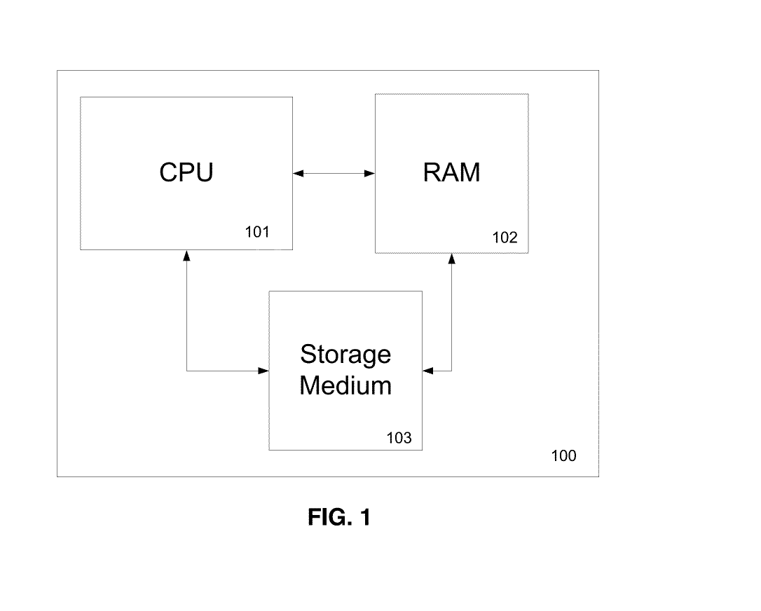

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

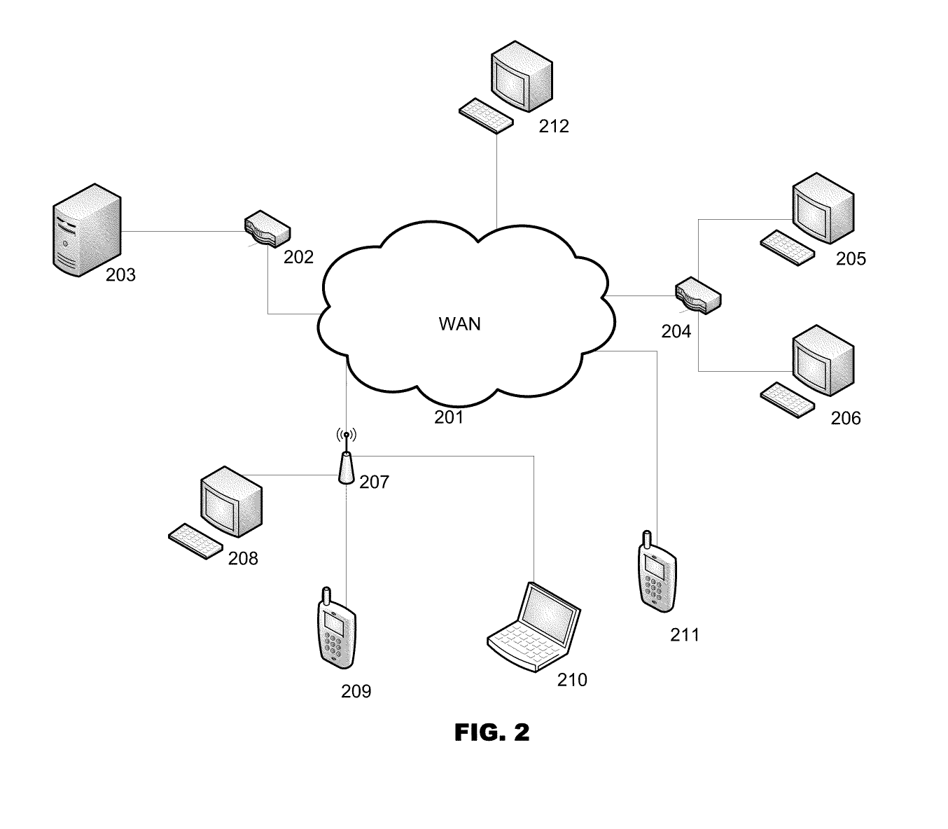

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an exemplary embodiment, The system and methods described herein involve taking multimedia files and professionally moderating them through a series prepopulated categories, sub-categories, and sub-sub categories with the objective of grouping multimedia files into related genres. In addition, the multimedia files are subjected to time limits and constraints which confine the amount of material submitted depending on category, sub-category, and sub-subcategory.

In addition, similar subject matter multimedia files are viewer selected and grouped in series of two or more. In addition, the multimedia files are subjected to a weighted evaluation system that allows viewers depending on their level of expertise to vote and/or select their preference of one or more multimedia files.

An example, but not limited to, how this process would work: A user of this invention would take a video of his friend doing a surfing trick (the sport of surfing). In the uploading process the user would select prepopulated categories, sub-categories, and sub-sub-categories that define and editorializes the video. The process continues by limiting the length of time of the video based on the pre-defined categories, sub-categories, and sub-sub-categories. If the video is longer than what is allowed the user must select the most exciting aspect of the video that fits in the time limit allowed. Using in this example the category of Surfing, sub category Amateurs and sub sub-category Tricks, this video would be limited to 1 minute (other lengths may be used). The video would then be uploaded to a platform where it is displayed in a series of 2 or more and evaluated by the public and others with varying degrees of expertise in that particular subject matter.

In our example, when a member of the general public views the series and gives our surfing video example a positive evaluation; that evaluation/vote would be worth one point. As our example video continues to escalate in ranking in relation to other surfing videos, it would then be seen and evaluated by industry leaders and experts. Positive evaluations from these leaders and experts would carry more weight and more point/vote value and allow the video to advance to higher rankings (For example, a general public vote would be worth 1 point while an expert vote would be worth 100 points—any amount of points/weights may be used). Level and amount of remuneration is connected to the advancement and ranking by general public and experts of the video.

In our example, the when the surf video is first uploaded it is subjected to evaluation and once arriving a low level ranking can be remunerated by public donations (goodwill), once it hits the next level by virtue of the weighted evaluation system of general public and experts, the surfer can earn corporate and larger sponsorships, upon reaching a higher level the surfer can be awarded team membership, contracts, etc.

In our example we saw a young surfer use the invention to have his video seen within a group of like genre videos, time limited to the best portion of the video, evaluated by his peers and then evaluated with heavier endorsement by industry leaders and experts. The increased amount of remuneration was directly connected to the escalation and ranking of his video.

Embodiments of the systems and methods described herein are useful for many reasons including but not limited to

1) It allows for multimedia files to be professionally moderated and grouped into very specific genres and categories. This avoids the problem of using tags, search terms, and descriptions that are often misspelled, misapplied, and not accurate. The invention assures all multimedia files are editorialized and grouped appropriately.

2) By limiting the time limit or size of a multimedia file it assures the viewer is getting the best portion of the file and enhances the experience so not needing to sit through mediocre material to see exceptional material. It also gives all files the same time restrictions so that evaluation is easier.

3) By having a weighted evaluation system, we are able to give a more exact rating/score as to entertainment value for the public and professional critique by experts and industry leaders. It avoids, fixes, and discourages the problem of spamming in point related competitions since experts will have more authority and can by their votes overthrow possible manipulations and efforts to fix (sec) the scoring system. It also benefits the user/uploader as the invention encourages and allows for his material to be seen and evaluated by experts and industry leaders. The process of weighted evaluation also adheres to the public evaluating with an untrained eye but voting as to what they like and then as the material is elevated it is then evaluated by a trained eye of a professional. The result is contestants that are both liked and enjoyed by general public and endorsed by more critical professionals and experts looking for skill and ability.

4) The invention is useful in the way it remunerates participants in an advancing system connected to the weighted evaluation because all participants have potential for some remuneration and not just one winner. It also assures the ones gaining the most remuneration are qualified/rated both by general public and then by experts which avoids a public driven winners or expert driven winners. This is further useful in that the remuneration is appropriate to ability and entertainment value.

5) Having the multimedia files evaluated in a user selected series of two or more is useful as different users will not generally pick the same multimedia files to be compared against each other and by virtue of multiple series building and viewing by multiple viewers and users the best will naturally be selected out in a very fair and manipulated process.

According to an exemplary embodiment, the system and method in question is novel for a number of reasons but not limited to, it editorializes and categorizes multimedia files (which is different from tagging, adding search terms, or creating/inventing categories as per standard practice), limits the time to appropriate lengths for selected genre (which is different from the standard practice of uploading multimedia files of various lengths, size, and quality), evaluating and ranking from a bottom up process giving those with less expertise a lower value to their points in contrast to experts who know the subject well to rank/vote with more weight in relation to the subject matter (This is in contrast to current practice of all voters have equal weight, or selecting quality by experts first and then allowing general public to weigh in and elevating content by virtue of sheer numbers), the user selected file process allows for unmanipulated ranking and evaluation allowing best to survive and rise to the top (current practice is to have a selection of contestants already selected and presented which results in a very legislated and restricted outcome), the escalating remuneration is based on the result of all the above giving a level platform for all to be remunerated based on a fair unmanipulated rating system (current practice is to remunerate based on a chaotic mix of expert opinion, life circumstance, available resources, personality or unrelated talent, fixing of online ratings, etc).

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for moderating, evaluating, and escalating multimedia files.

2. A system for moderating, evaluating, and escalating multimedia files.

3. The invention as described herein.
